(19) United States
(12) Patent Application Publication
(10) Pub. No.: US 2007/0150330 A1
(43) Pub. Date: Jun. 28, 2007

(54) Rules-based method and system for managing emergent and dynamic processes

(76) Inventor: David O. McGoveran, Boulder Creek, CA (US)

Correspondence Address: David O. McGovern, P.O. Box 2097, Boulder Creek, CA, 95006, US

(21) Appl. No.: 11/708,105

(22) Filed: Feb. 17, 2007

Related U.S. Application Data
(63) Continuation-in-part of application No. 09/476,711, filed on Dec. 30, 1999.

(51) Int. Cl. G05B 19/418

(52) U.S. Cl. 705/8

(57) ABSTRACT

This invention details a method, and a device incorporating the same, for managing and controlling dynamic and emergent processes, including multi-entity business processes and enterprise workflow. The method is declarative, goal-driven, enables continuous modification in response to real-world events and measures, and capable of adaptation through self-modification.

### 1. FIELD OF THE INVENTION

This invention relates to a computer-implemented method and system for using a system of rules to support process automation. More specifically, the present invention uses a multi-level organization (possibly hierarchical and nested) of declarative rules, goal, conditions, actions, constraints, measures, to enable evolution, management, modification, and analysis of both emergent processes and dynamic processes responsive to a real-world environment, without the definition of the process needing to be fixed or known in advance.

Throughout this specification, underlined section sub-headings are present solely to enhance the ready comprehension of the reader and do not convey aspects of the invention in and of themselves.

### 2. DESCRIPTION OF THE PRIOR ART

Business management has been traditionally viewed as a ‘soft’ art, subject to all the vagaries of human capacities and behavior. Corporations and other organizations, irrespective of the precise status of their legal existence, have been the continuously-modulated expression of their human employees' interactions with each other and external circumstances. While each organization was (when viewed from the outside) theoretically a collection of behaviors with defined goals, constraints, and activities, in practice, it was only the shadow of actions of the individuals who at that time were its constituents.

Yet organizations and corporations persist over and past the tenures of their individual human constituents. They develop patterns and knowledge that are transmitted to and through their human actors. If not now, in the near future, we will see autonomous and automated agents implemented on computers acting for and on behalf of businesses. To the extent that these patterns and knowledge can be captured and transmitted, they are capable of being shared throughout any organization and across organizations.

Most business entities have been functionally organized with a greater-or-lesser degree of hierarchical organization, wherein a first, higher, operating level tells a second, lower level what to do. This approach focuses on specifying for the ‘subordinate’ the details of his or her tasks, while leaving implicit the goal of such tasks. It also leads to a great deal of separation between the knowledge of the ultimate purpose of any operation and the knowledge of how such purpose is in fact being attained. Process information is at best implicit and often is neither recorded nor tracked. To a certain extent the business entity becomes its own ‘black box’ insofar as the capability of any one level to determine how well it is in fact functioning depends entirely upon the correct reporting up, down, and across the hierarchy or other management structure.

There have been many flaws found with the hierarchical, functionally-organized, traditional business management method. Solutions have been suggested ranging through the theoretically esoteric “management by objective” approach, to the ‘total quality initiative’ (Hannula, 1999), to the more recent pop-valued “Ready. Fire. Aim” made well-known by popular business-management author Tom Peters in his 1992 book. These solutions, while they have provided generations of consultants with work and fees, have not been adopted, for the most part, due to a number of flaws. Not the least of which is the lack of a means for instantiating such in a verifiable logical structure or using a non-human computational test bed. When your only means to simulate a new method is in the real world and failure is the price of any flaw, experimentation and testing becomes crisis-driven rather than proactive.

One approach in the prior art is referred to as the ‘balanced scorecard’ approach (Norton, 1999). However, this is a purely passive measurement divorced from action (according to the author, strategy is to be manually “translated” into actionable measures via cause-effect relationships, a creative real-world analysis that can be computer-assisted, but not automated), and is furthermore not capable of modifying itself to meet internal flaws. Both of these weaknesses are eliminated in this implementation of the invention.

Two similar concepts, the first of building parallel, distributed systems, and the second of closed-loop control, come from the related fields of computer science and operations research. However, each mandates as part of their approach a single, rigid, and unitary solution to a particular problem, whose success depends solely on the original correctness of the model's meeting the real world. Since all models are by necessity and human limitations both inadequate and incomplete, and since the real world changes over time, these two methods lack the flexibility and adaptability of this embodiment of the invention. Neither of these concepts has control elements that are declarative, discrete, or implemented via rules, but instead attempt to simulate analog control systems.

At present management is generally hierarchical, process-oriented, and backwards-looking. Management is hierarchical in that directions and decisions flow downwards while information flows upwards, with coordination between or across levels happening despite, rather than as a part of, the formal management process. Review of a business' processes, that is, of its entire reason for existence and practices, are directed by the higher levels rather than evolving out of the events experienced ‘on the line’, that is, by those individuals in contact with the world outside the business.

Similarly, management is process-oriented in that managers tell subordinates what they should be doing, and even how they should be performing their tasks within the context of a (typically implicitly understood) process. Managers act as the brains, while subordinates act as the muscles (in part due to the historical evolution of larger-scale businesses from the earliest manufactories). The evaluation of the processes themselves, rather than the performance of the subordinates, is generally both limited and occurs only as a meta-level activity, though the venue of the ‘suggestion box’ provides at least a limited feedback channel (consider, for example, the traditional mechanisms for continuous process improvement).

Finally, management is backward-looking (e.g., Norton, 1999) in that a new period's expectations are driven by the data of what happened in the past (e.g., via trend analysis, key performance indicator baselines, benchmarking, etc.). Each quarter's activities are guided by projections from the records of the performance during past quarters (or longer periods). Production is driven by anticipated or projected sales, rather than by accumulated orders or proposed developments. Sales quotas are set by analysis of the past economic data concerning potential customers. The history of businesses operating in the era of mass production resembles the course of a vehicle being driven backwards with the driver peering into his rear-view mirror, with all the course-corrections, hesitations, false moves, and occasional crashes one could expect from the process of backing into the future.

Three common methods of management currently are: (a) Management by Objective; (b) Statistical Management; and (c) Workflow Management. Aspects of each have been at least partially supported by computer implemented methods in the prior art. These three methods are below summarized below.

All of the weaknesses in current management practices described below are the consequence of separating process information from the feedback experienced when the business activities meet the real world conditions. All three of these separate decision support (i.e., tracking of information about what occurred, relating the same to what was done, and predictive or analytical modeling) from decisive action, leaving the business prone to unexpected errors (subsequently explained away or covered up, often depending on internal ‘political’ agendas of the subordinate managers), surprising and unexploited successes, or the vagaries of chance synergy between reality and model, rather than the conscious correction of the latter to the former.

Because the method of the present invention avoids this separation (in fact, it actively seeks integration of these elements), it avoids the flaws described below.

Management By Objective

In Management by Objective (introduced by Peter Drucker in 1954), managers set goals (objectives) their subordinates must meet. The grounds for the goals, the consequences of attaining (or failing to attain) these goals on the rest of the business, and more detailed measurement beyond succeed/fail, are not considered pertinent in this approach. Subordinates are unable to examine (and possibly correct) mistaken assumptions that may lie behind the goals, erroneous processes which may interfere with attaining them, or suggest alternative goals which may better serve the grounds underlying the goals. Moreover, the feedback as to the effectiveness of this approach, being limited to a single value (succeed/fail), either requires such specificity and particularity in the goals as to make record-keeping too burdensome, or makes the records so indeterminate as to the quality of the processes by which the goals were attained in any given period that those records will not help improve future performance. Computer implemented balanced scorecards, quality measurements, and key performance indicators provide one means of reporting on and monitoring progress toward objectives, but are limited in their applicability to select portions of a business and do not provide integrated means to evolve in response to changing internal, external, or real-world conditions.

Statistical Management

In Statistical Management (based on the work of Sir Ronald Fisher in the 1920s), as many elements of a business' performance, and of the external world's conditions, as can be stated in objectively measured elements, are placed into some numerical (ordinal or otherwise) value. Then the performance of the business is guided by the need to meet or otherwise explain these numbers. The largest two problems with this approach are: (1) there is no way to apply a self-correcting mechanism for failure to accurately state a value at any time, so inaccurate projections cannot be distinguished from failed performance; and (2) there is no way for the management to distinguish which of multiple approaches actually explains attaining the numerical values, making it impossible to do anything but guess as to which process that produces the numerical values also produces a superior business value. (For example, a sales volume requirement may have been met by stuffing a channel or by failing to meet unexpectedly high demand, but the volume alone cannot tell which occurred.) Even when augmented with statistical forecasting and modeling techniques, statistical management techniques fail to connect statistical values with operational procedures. In addition, they are not self-correcting, they do not encourage improvement of the model over time, do they do not provide fine-grained control, and they remain deeply mired in the historical trends rather than anticipating future requirements so as to allow agile response to changes. Statistical Management, including statistical process improvement, may be understood as an approach within the broader Scientific Management, and many computer implemented methods pertaining to process management rely upon its techniques.

Workflow Management

Finally, a Workflow Management approach (see, for example, www.wfmc.org for a definition) specifies the pattern of behavior that the individuals working in a business will engage in, usually in a temporal or causal sequence (production of a sub-part preceding production of the whole item that will be sold). The intention in this approach is to focus on the ‘critical path’ of events that must occur for an entire process to succeed. However, failure at any critical point leaves the entire business scrambling ‘out of model’ for alternative solutions and represents a breakdown of the management process (at least in a theoretical sense, though all too often also in a very real sense). Additionally, workflow models of a business are quite restrictive in that they do not directly incorporate any of the following: reverse flows (as required, for example, by manufacturing rework), conditional iteration, hierarchical workflows, or complex branching, and omit many other real-world business process flows. Instead, these must be indirectly and partially modeled, which results in a costly misalignment between the Workflow Management and business practice.

Computer implemented variations on, and extensions of, workflow management include document management, process automation, and business process management. Document management systems implement a functional subset of workflow management that pertains to modifying a document or folder (containing or representing the subject of the work) through a sequence of steps (the “flow”), each step being assigned to an available knowledge worker. As a task is completed, its result is recorded in the document or folder and the next step in the flow is triggered. Limited automatic response to errors (e.g., a timeout) may be supported, typically generating an alert requiring manual intervention.

Process automation historically addressed continuous chemical manufacturing processes (e.g., petroleum refining) in which materials were transformed via a series of steps (the “process”). Computerized monitoring and control of process, including routing via pipes and valves, automated the process. Extensions of these concepts have been applied to discrete manufacturing processes and to integrated software components in information processing, and are still referred to as process automation. Routine tasks that define the process are automated, but there is usually only limited automatic response to errors and exceptions (e.g., emergency shutdown).

Business process management is an extension of workflow management concepts to business processes in which multiple units or subjects of work may participate and therefore, multiple workflows. Business process management software in the prior art may incorporate both manual and automated steps, include a hierarchy of sub-processes, may use rules to select among pre-defined process alternatives (e.g., content based routing), and may even partially represent the process as a fixed set of rules (see, for example, Q. Chen and U. Dayal, 1996) differing from the manner in which the process is initially modeled. However, the prior art fails to address automated means for resolution of logical contradictions among such rules.

The prior art of computer implemented workflow management (including so-called ad-hoc workflow), document management, process automation, and business process management fails to disclose any method providing for general support for any of emergent processes (e.g., Glance, et. al., 1996; Haake and Wang, 1998), process/workflow reflectivity (e.g., Cugola, 1998; Tombros, 1999), process dynamism (e.g., Kammer, et. al., 1998), or dynamic composition (e.g., Kammer, et. al., 1998). Processes and workflows must be defined predominantly in advance of implementation, and there is limited support for incremental modification of the definition, let alone modification during execution. Any significant alteration of the definition typically requires creating a new version of the process, if not an entirely new process.

The relevant prior art includes literature pertaining to computer-based technologies including rule-based systems, workflow management, and process management, and to business management. None of the prior art discloses or teaches the present invention.

Rule-based systems are well known to those of ordinary skill in the arts of designing and building artificial intelligence and expert systems, and declarative rules have been used within many types of software systems. There is a vast literature on the use of declarative rules for knowledge representation, validating data entry, constructing and maintaining applications, advisory systems, workflow representation and enactment, inferencing, and so on. Various “rules engines” for managing and manipulating a collection of rules as a service (e.g., U.S. Pat. Nos. 6,285,985 and 6,163,604) are available for commercial use, and have been since at least 1998 (see, for example, www.ilog.com, www.corticon.com, wwwjessrules.com).

Computer implemented methods for representing and enacting dynamic processes (as defined herein) are well known to those of ordinary skill in the software arts pertaining to process management and workflow management. However, the prior art applied only to limited subsets of the dynamic process characteristics found in real-world systems. At least as late as 1996 (see Glance, et. al.), it was well-known that “no CSCW (computer supported collaborative workflow) system or work representation formalism is capable of spanning the entire spectrum, giving workers full choice about when to specify process representations, to what level of detail, and to what extent coordination should be delegated to the support system.” Features referred to as process dynamism (the ability of a process definition to change during enactment), reflectivity (the ability of a process to alter its own definition), emergent processes (the ability to accommodate an incrementally emerging, rather than pre-defined process definition), and dynamic composition (the ability to compose process elements just prior to or possibly during enactment) are known to be highly desirable in representing, managing, and optimizing dynamic process enactment, but little progress was made in the prior art to address these issues. The prior art literature pertaining to workflow management and process management (especially business process management) discloses certain aspects of the present invention, but fails to disclose or even suggest the particular combination of using declarative rules in a goal-driven process having the structural, organizational, and self-modifying elements of the present invention, or its many benefits.

According to Glance, et. al. (1996), “ . . . traditional workflow with a process description language (PDL) permits adaptation to change via conditional statements in the process template anticipated before process execution and changes to the process definition during execution expressed as deviations from the process template.” As an alternative to these limitations in handling process change, Glance discloses a generative grammar approach to defining the potential process space for flexible work representation. The grammar is based on rules, objects, features, and constraints. Emergent definitions of sub-processes are case-specific and constraints are used to specify flexible temporal dependencies among activities. Process state dependent triggers are described. Like the present invention, the emphasis is on potentiality rather than pre-defined and rigid process description. Constraints are used to “snip away the background allowing the outlines of the process to gradually emerge in the foreground during enactment”, so that the method supports both process dynamism and emergent process. Glance discusses some of the value of flexible work representation including: helping workers reason about work and (re)plan activities; the location, adaptation, and modification by workers of the most appropriate sequence of tasks to get things done (including short cuts, exception handling, etc.) while respecting constraints; and the capture and enactment of different work coordination mechanisms. Glance fails to address managerial or analytical methods or benefits.

In Glance, et. al., the stepwise refinement of activities is controlled by “activity-centered rules” that describe both the decomposition of goals into sub-goals and under what conditions, resulting in a hierarchy of process elements. However, Glance does not disclose the use of measurable goals and objectives or delegation to specify such stepwise refinement as is found in the present invention. Glance notes that, although earlier work used a grammar and constraints, it was only to parse a set of actions in order to check process definition “correctness” or considered only temporal constraints as a method of partially determining activity order. In Glance, constraints, rather than the satisfaction of rule conditions, determine activity order in the process. Glance (Introduction, p. 1) teaches away from the present invention, asserting that collaborative systems are for sharing common artifacts, not to accomplish a goal as in workflow. With respect to flexibility, Glance notes that approaches using Petri nets and their variants require designer to specify entire process ahead of time and “at best some approaches allow limited flexibility: roles to attach responsibility, and sub-plan elaboration on the fly.”

Haake and Wang (1998) review certain other prior art, including (1) systems that enforces predefined workflows but turn to an administrator for decisions when the process is ill-defined (CSE/Workflow), (2) unresolved questions regarding applicability of work models due to ontological drift, (3) the use of declarative modeling using rule-based scripts as in Zippin, and (4) automatic process definition inference (TeamWare Flow).

Haake and Wang are focused on methods to incorporate hypermedia in document-centered workflow, and disclose a system of representation and enactment using task nodes, process links, transition conditions, pre/post conditions, actors with computational semantics to describe constraints, operations, and triggering conditions in an activity space. Their system is not based on rules, but on actors that can be implemented via computational semantics using, for example, object oriented programming languages. Their system provides support for emergent process, but is not rule-based and discloses none of the other features of the present invention.

Kammer, et. al. (1998) address the problem of process definition changes driven by exceptions. In supporting the importance of handling exceptions, they quote Suchman as stating that “exceptions are a fundamental part of organizational processes.” Sources of exceptions and change described by Kammer include inconsistent data; divergence of tasks; unexpected contingencies; unmodeled changes; the need to evolve, expand, optimize process; and dynamic organizations. They note that handling the last of these is goal of the management techniques of continuous process improvement and TQM, which are iterative redefinitional approaches rather than addressing process dynamism directly. In discussing the need for adaptive capability, Kammer categorizes the functionality of adaptive characteristics (such as process dynamism and reflectivity) versus their goal.

The system of Kammer, et. al., deals only with a subset of exceptions called unexpected exceptions. Kammer teaches detecting, avoiding, handling, and recovery from exceptions and by handling means tolerating minor deviations, changing a process instances (i.e., temporary runtime changes), and evolving the process model (i.e., definition). Kammer teaches away from the present invention, asserting: “Strict consistency cannot be followed in a process model. Coordination among dispersed participants is difficult; assumes need for uniform representation of activities, artifacts, and resources among people, groups, and organizations.”

Kammer discloses other prior art systems for addressing process dynamism as a way of handling exceptions. Methods mentioned include late binding, on-the-fly composition, configurable execution models (partial execution—dynamic composition and process fragments via iteration, sub-processes, etc.; guidance versus enforcement approaches).

Kammer defines process reflectivity as meaning that, during execution, the process has the ability to remodel itself, and teaches the use of logically decomposable processes so that fragments can be assigned at runtime. The system of Kammer is an event-driven architecture that uses Java objects and triggers of object handlers rather than rules.

Cugola (1995) discusses process adaptation in the context of the software engineering process. The representation of processes is as a set of state machines wherein legal state transitions are controlled by preconditions. Unlike the present invention, the method of Cugola uses rules solely in responding to “pollution”—a situation peculiar to state-driven process representations in which bad data, decisions, design, and the like result in propagation of erroneous states.

Chen and Dayal (1996) disclose OPM (Open Process Management System) in which the representation comprises a hierarchy of nested processes and OPM has transactional properties (the nested transaction model). Chen and Dayal teach using constraints on open activities (i.e., not rigidly defined), correction of errors via transactional rollback, the use of Event-Condition-Action rules for implementing dynamic process modification, and the use of constraints to at least partially specify interactivity dependencies. The method taught has limited use of rules, requires separate event specification, is not goal-driven, does not address delegation, has limited process reflectivity, and does not address measurable goal completion. Unlike the present invention, it requires a sophisticated transaction model in order to avoid a low level and flat specification of a business process.

Borghoff et. al. (1997) teaches a method of implementing a degree of process dynamism and process reflectivity. The method of Borghoff uses a “reflective agent” that uses meta-level activities to observe and modify its own behavior so as to adapt it to changes in the environment. Agents exhibit both reactive and deliberative behaviors. Internal control is based on representations of its state, abilities, past actions, goals. Declarative specification of coordination, causal dependency (rules at the object level), and activity or task prioritization schemes are disclosed. Process dynamism is implemented via synthetic cut-over, defined as a method of representing equivalent process definition fragments and then selecting from among equivalent alternatives at runtime.

The disclosed system is a rules-based model of reflective agents, which use rewriting rules as in planning tradition to modify the process definition. Rules are defined in a manner similar to those the present invention; the rule head (rhs) specifies a requirement of agent state, and the rule body (rhs) is executed when the rule head is satisfied. Rules in the disclosed system are classified into one of reified rules (rules that have their name in the trigger), recording rules (keep evolution of process), deliberating rules (partially determine agent evolution), tracing rules (past actions), reporting rules (update meta-level representations of resources), meta-rules (rights for execution of reified rules), planning meta-rules (modify future actions component of rules representations), and enactment rules.

Endl, et. al. (1998) discuss the translation of business rules into formal representations, citing Bell's definition of business rule as “statements about how business is done, i.e., about guidelines and restrictions with respect to states and processes in an organization.” Endl elaborates on the representation and implementation of rules as found in the prior art active database management systems. There, rules have a more complex structure than condition-action (CA) or event event-condition-action (ECA), requiring instead ECAA—On Event, if Condition, then do Action, else do Alternate action. Endl expands this concept to permit ECⁿAⁿ (multiple conditions and actions) constructs. A method of stepwise refinement of business rules similar to the present invention is disclosed in which a high level rule is replaced by a network of rules having the same initial E and the same terminal AA, but may be intermediated by a complex sequence, iteration, etc. In other words, the detail is a subprocess described by rules and is black-box substituted. Note that, unlike the present invention, there is no delegation hierarchy, no concept of measurable goal, no concept of passing goals downward and results upward, no inferencing, no forward or back chaining etc. Processes (or subprocesses) are not emergent. Instead, the connection between rules must be pre-defined in order to represent the process. The purpose of the refinement is to connect high level “Bus. Rules Oriented Process Model” (generic representation of multiple process model representations) to the “Bus. Rules Oriented Workflow Model” (multiple workflow systems, active DBMS, etc.) Rule actions as disclosed as being possibly trigger of actors.

Ellis and Rozenberg (1995) address process dynamism and dynamic composition via synthetic cut-over using a Petri net representation. Rules are not used and the method is not goal-driven.

Kumar and Zhao (1997) introduce a declarative method for routing, monitoring (quality and efficiency of operations for managerial purposes), control (prohibit unauthorized operations), operations (carry out automatic actions when specific conditions met), and exception handling. The method is based on event-based workflow management rules given via “Process Constraint Language”, which the authors show is more expressive than Petri Nets. It requires rules be defined as having an Event-Role-Object-Condition-Action structure, meaning “for rule having <Rule-id> on <Event> by actor having <Role> to <Object> if <Conditions> then do <Actions>.”

The paper discusses issues of rule consistency (but only discloses enforcing rule consistency prior to runtime), non-functional rules, rule indexing, and rule conflict resolution. Unlike the present invention, it does not disclose dynamic inconsistency resolution, implements no hierarchy, is not goal-driven, has no inferencing capability, etc.

Cugola, et. al. (1995) and Cugola (1998) describes the PLAN language comprising attributes, states, external operations automatic operations, methods (local to artifact), invariants (overall constraints that must always be satisfied by artifact state). Deviation types are user (wrong user), condition (executed when state in guard list but not predicate not satisfied), state (state not in guard list), and precondition (execute even though not satisfied). Five (predefined!) policies disclosed to deal with deviations—abort, inform user and abort, ask user, inform user and continue, continue. The system described by Cugola enables a degree of limited degree of intentional process dynamism including change of policies per user at enactment time and change of the consistency checking policy at runtime according to policies that govern how to respond to levels of violation severity (stop enactment, stop object enactment, inform process manager and continue, continue). Cugola discloses the use of Boolean expressions (predicates) on the values of artifact attributes (i.e., their state) to express activity start conditions, thereby specifying the process as a state machine. External operations consist of name, formal parameters, agents (i.e., users), guard, precondition, and Java body.

Cugola discusses other prior art including PEACE and SPACE. Two 1994 references of Arbaoui and Oquendo are reviewed by Cugola: “Peace: Goal-Oriented Logic-Based Formalism for Process Modeling” and “Managing Inconsistencies Between Process Enactment and Process Performance” (the latter regarding inconsistencies caused by uncertain and incomplete knowledge in observed process). The goal-oriented language PEACE formalizes parts of a process model using an auto-epistemic logic and supports reasoning about differences between users beliefs and the actual process. Cugola notes that that SPACE has self-modifying capabilities.

Davulcu (1998) teaches that the three most common methods of depicting workflows are control flow graph (with transition conditions, loops, sub-workflows, alternative execution, compensation, inability to specify global dependencies between tasks), triggers as ECA rules (inability to specify global dependencies between tasks, hard to express OR nodes, can always be compiled into control graph), and temporal constraints. Discloses Concurrent Transaction Logic, an extension of first order predicate logic with modal properties and special connectors.

With respect to the prior art, Davulcu teaches that certain temporal constraint methods (e.g., the algebra of Singh) are not able to query intermediate state of workflow and make scheduling decisions based on the outcome.

Zamli (2001) provides a review of prior art process modeling languages. Of those discussed, only Grapple (cited as 1988), APEL (cited as 1998), Marvel (cited as 1988), Alf (cited as 1994), and PEACE (cited as 1994) make use of either rules or goals. Each of these prior art systems is designed to address the software engineering process. None of these systems supports process reflectivity, emergent process, or process dynamism. The discussion of Zamli is paraphrased in the paragraphs immediately following.

Grapple is based on the artificial intelligent planning paradigm. Software engineering processes are defined in a goal-subgoal hierarchy using plan operators with multiple levels of abstraction. It does not use rules to either specify this hierarchy or permit it to emerge and evolve. Preconditions for operator are disclosed, and operators effect state changes. Plans emphasize goals over activities. Both plan generation (which automatically executes process steps to achieve a goal) and plan recognition (which attaches executed steps to the current set of plans) are disclosed. Plans are constructed dynamically from a system of rule-like (software engineering) operators based on non-monotonic reasoning. Grapple attempts to prevent conflicts among them, but discloses no method to resolve contradictions. Grapple plans are not self-modifying. Grapple is not designed for management of an executing process (enactment), but for intelligent assistance in developing a software project plan. Thus, its methods are not suitable for dynamic processes as disclosed in the present invention.

In the graphical high-level Abstract Process Engine Language (APEL) language, the software process is described using Object Management Techniques-like diagrams, data flows, control flows, workspaces and cooperation and roles, and state transition diagrams. APEL discloses using the Goal Question Metrics (GQM) model from the Quality Improvement Paradigm. GQM is an approach for goal-oriented measurement in software projects which support pre-defined measurement of products and pre-defined processes for improvements. The plan consists of a goal, questions related to the process model, and metrics (measures). It is neither goal-seeking, automatically adaptive, nor rule-based.

Marvel Strategy Language (MSL) is the process language for Marvel and is rule-based. Marvel discloses modeling the software process as an extensible collection of rules stored in an object-oriented database. Process steps have preconditions and post conditions, and rules are interpreted using both forward chaining (execute steps opportunistically when pre-conditions satisfied) and backward chaining (finds steps that will enable a given step's pre-conditions to be satisfied). The only sense in which Marvel is goal driven is that it seeks to meet and optimize scheduling goals. Marvel is not goal-driven, and the process specification is not organized into levels (although objects are organized in a structural hierarchy).

Model for Assisted Software Process Description Language (MASP/DL) is the process specification language for Alf, and describes a generic MASP software process model. A generic MASP software process model is disclosed as composed of software process fragments including an entity relationship attribute (to describe data), a set of operator types (abstraction of tools and pre/post conditions), a set of rules of type event-condition-action (for response to pre-defined events), a set of ordering constraints (controlling temporal ordering of operations), and characteristics (i.e., invariants and objectives). It is not goal oriented and the process specification is not organized into levels.

Process Centered Enactable and Adaptable Computer Aided Environment (PEACE) adopts a goal-oriented approach, emphasizing goals over activities in the process definition (i.e., in modeling and specification). A PEACE software process model is a set of process fragments similar to Alf. The specification is described in terms of an object model using a data definition language and an operator model. Each process steps are described in terms of its name, input and output, its intrinsic role, pre/post-conditions and its incoming and outgoing events. An improvement of PEACE called PEACE+ extends enactment support for distributed process model and support for iterative process evolution (through rudimentary process dynamism). It is not rule-based.

Although the prior art has increasingly recognized the need for adaptation to change in business processes, the prior art did not presume a rapidly changing world but an essentially static one in which processes can be largely pre-defined. Failure of business process to be responsive to the current context is a major problem with the prior art that has been specifically identified. A naïve understanding of project management prior art would suggest some possibilities for computer implemented application to the problems of dynamic processes. However, the project management prior art is concerned with planning solutions (i.e., scheduling resources given a set of constraints and actor interdependencies).

Jennings, et. al., (1996) describe certain characteristics of industrial and commercial business processes, which we paraphrase here: (i) Multiple organizations are often involved, each having its own goals and constraints (e.g., maximize profit); (ii) Organizations are physically distributed and form transient allegiances; (iii) Within organizations, there is a decentralized ownership of the tasks, information and resources involved in the business process; (iv) Different groups within organizations are relatively autonomous—they control how their resources are consumed, by whom, at what cost, and in what time frame; (v) There is a high degree of natural concurrency among many interrelated tasks; (vi) There is a requirement to monitor and manage the overall business process, possibly with global constraints (e.g. total time, total budget, etc.); (vii) Business processes are highly dynamic and unpredictable—it is difficult to give a complete a priori specification of all the activities that need to be performed and their order. Detailed time plans are often disrupted by unavoidable delays or unanticipated events (e.g., people are ill or tasks take longer than expected).

Jennings then discloses a system (ADEPT) to address (some of) these characteristics in which a collection of autonomous, problem solving agents interact and negotiate when they have interdependencies. Such agents exhibit proactive and opportunistic goal-directed behavior. ADEPT has both declarative and procedural knowledge bases. Its “KIF-like” language (i.e., an extended first order predicate calculus) for communication among agents is described as “still under development.” Unlike the present invention, ADEPT is not rule-based, the declarative aspects of the system do not provide an emergent and incremental representation of dynamic processes, and organization depends on how agents interact, rather than goal refinement or delegation structure.

The dissertation of Tombros (November 1999) reviews the prior art of workflow management (WM) technology and states that interconnecting islands of automation to form workflow or process systems that are enterprise wide or which cross organization boundaries “ . . . is still not possible with current WM technology . . . ,” that there are “still a lot of open issues,” and that “the development of distributed, process-oriented information systems poses complex problems which are currently the subject of intensive research.” Among the various related technologies disclosed is the prior art definition and execution model for event-condition-action (ECA) rules as found in active database management systems. Note that the present invention does not require a separate event structure in its rule composition; however, Tombros discloses prior art in which events correspond to changes of values in Boolean functions of environmental variables or achievement of a certain process state and thus monitoring of such as one method of responding to “events types” Coupling modes, which specify how event detection is to be followed by the triggering of associated rules, are discussed.

Tombros also discloses the prior art use of rules “needed to build a particular program, cross-reference information, profiling data, and information about the program execution environment,” for agent coordination in workflow systems, for pre- and post-conditions of computational components, for control flow and data flow, for event definition, for intertask state and value dependencies, for specifying reactive component behavior, for exception handling, for specifying state transitions in statecharts, for synchronization policies, and for human-agent notification. Tombros describes the prior art use of ECA rules as having the disadvantage that they are low level and tedious, a limitation overcome by the present invention through stepwise refinement and the use of levels. Prior art use of nested transactions (as in Dayal and Chen, discussed above) is mentioned as a way to overcome this disadvantage.

In reviewing the prior art pertaining to constraint-based workflow specification, Tombros states that “constraint-based workflow specification has its origin in AI techniques.” He goes on to describe one way in which rules are used in the present invention (“The specifications are expressed with rules of some form (condition-action rules). In general, the condition specifies some predicate to be checked and the action represents the workflow task encapsulated by the rule.”). Tombros discloses using forward chaining and back chaining to determine rule firing, also disclosed in the present invention. The rule-based Marvel software process engine (discussed above under Zamli) is used as an example of constraint-based workflow specification. Specific methods of processing rules are discussed.

Tombros discloses the prior art use of capturing process histories to add or modify rules, but fails to disclose any method to implement process dynamism or emergent processes via rules as found in the present invention.

Tombros discloses an event- and repository-based component framework for workflow system architectures. Tombros teaches the use of ECA rules via an underlying active database system for distributed workflow execution providing global temporal event ordering, but does not disclose or suggest how other uses for rules in the many prior art references might be combined into a uniform and consistent system. Rules are used to specify the response by components to events. The default behavior of a component and how that behavior is to be modified for a specific workflow is specified by a kind of rule set Tombros calls a “rules package”. Rules are used to specify subscriptions to events, execution of services by actors, enforcement of task execution ordering, guarding task execution conditions, and execution and failure handling. However, rules packages are not disclosed as a method for process dynamism, process reflectivity, or emergent process. REWORK processes are not self-modifying and Tombros even eschews self-modification by agents, while acknowledging that this is a key feature of other agent-based architectures. Unlike the present invention, a pre-defined partial ordering is required and must be respected so as to maintain transactional serializability. In this respect, REWORK uses rules to pre-define the process definition, rather than permitting emergent process or even incrementally defined process from the collection and structure of the rules, goals or objectives of processes, subprocesses, and activities, and constraints. REWORK also teaches using rules to specify a role as a set of skills (i.e., capabilities), but does not disclose any method for automatic matching of skills and requirements other than via manual assignment of those roles asserted to be required for a particular operation.

Although rules are generally described as declarative in the prior art, REWORK implements rules as “composite objects which reference compiled C++ code for condition evaluation and rule actions.” Furthermore, Tombros acknowledges that research indicates the black-box approach taken in the REWORK system is unlikely to be appropriate for cooperating heterogeneous process support systems, a limitation not shared by the present invention. REWORK permits organizational relationship objects to be created either during system specification or dynamically during workflow execution and dynamic assignment of service providers. REWORK does not provide a method for hierarchical (or any other) organization of a process specification, let alone one implemented via rules and goal refinement to create multiple levels.

Nothing in the foregoing discussion of the prior art is intended to disclose the invention, but rather to present the prior art against which it should be compared. As will be clear to those of ordinary skill in the software arts related to dynamic processes, the prior art discussed above adequately teaches the necessary prior art components of the present invention (e.g., rules with conditions and actions, using rules in various ways for process specification and enactment, etc.) that will enable one of ordinary skill in the relevant arts to implement the present invention given the disclosure in this specification. The prior art also teaches the desirability, utility, and concrete, real value of the achieving many of the benefits of present invention. However, the prior art fails to disclose the invention disclosed below or all of its elements, especially certain derived components (e.g., rule-based multi-level process specification with measurable goals and delegation) or how components are to be combined to achieve the invention. Indeed, in teaching how to make specific use of some of the components of the present invention, some of the necessary multiple prior art references involve incompatible implementation architectures. For example, some prior art referenced above is not rules-based and a compatible rules-based implementation of the relevant feature (e.g., goal refinement) is not suggested by the prior art. Each of the prior art references discussed above is incorporated by reference herein in its entirety. The present invention, while relying on the prior art to the extent it is disclosed above and to which it represents knowledge accessible to those of ordinary skill in the arts pertinent to dynamic process specification, management, execution, analysis, optimization, and so on, teaches a novel and unobvious combination and application of that prior art as described in detail below.

### OVERVIEW OF THE INVENTION

The embodiments of the invention described herein recognizes that for any business entity, and most particularly for those which extend beyond a single individual, a method of business management can be adopted that both creates greater attunement to current reality and operates to lead towards the entity's objectives. This method focuses on explicit and measurable progress rather than intuitive and innumerate operations and so can be more readily and rapidly improved upon or adapted to changing circumstances, both external and internal. Accordingly, while this method is stated as one for active managing of a business operation, it is also suitable for analysis of a business operation. Moreover, it can be used for any of manufacturing, process, or service businesses as long as their goals and operations can be specified as set forth below. Furthermore, though the preferred embodiment of this invention is stated for a single business entity, it can be applied to more than one, by handling any particular grouping as a ‘black box’ whose inputs and outputs, but not internal logic or operations, are all that need be measured and accounted for.

The method of the present invention, because it focuses on stating goals and incorporating feedback that continuously updates a business's model to the real world, is an approach that integrates transactional practice (how events occur), operational practice (how the business functions), and informational practice (what is done with the knowledge generated during transactions and/or operations. The information about a process (how it is to be done), its expectations (what the process is meant to attain), its context (what the real world conditions are actually like), and its results (what actually occurred), is integrated into the business model as these elements are known. Furthermore, the method of the present invention, by integrating the feedback into the business processes themselves, forms what can be described as closed-loop decision making, in which objectively-stated expectation leads to effort leads to result leads to feedback leads to improved objectively-stated expectation.

By stating the goals of a business in declarative form, wherein the goals are specifically stated as measurable objectives, and the means for attaining the goals in similar declarative form as rules, wherein the internal and external real-world conditions are used as preconditions that, when met, allow the rules to actuate, and then repeatedly circulating through the rule sets (with each rule actuating only when it is logically, that is, ‘true’ for it to do so), a business can focus on attaining its goals rather than on how it is acting. By further allowing the modification, deletion, and creation of new rules, and new rule sets, to meet or correct for increasingly detailed specifications, newly-perceived real-world truths, newly-determined business goals, and newly-encountered internal contradictions, a flexible, adaptive, and dynamic method for business management can be realized which minimizes risks, allows for the capitalization of human knowledge, and moves from a production-push to a demand-pull method of management suitable for the modern era. As authority, responsibility, and accountability are delegated in a linked fashion to attainment of business objectives and subordinate objectives, internal and external flaws or differences between the business' internal model and the external reality are more accurately tracked and correctable with a minimum of management.

If instantiated upon a computer, the amount of detailed interaction and management that is needed to meet with real-world complexity and differences between projections, models, anticipations, and reality, are reduced. Moreover, continuous and incremental improvement at the most appropriate level of granularity of measurement and action can be devised and adapted through experience rather than having to be entirely pre-planned and specified. Furthermore, because the implementation can be both incremental and from either top-down or bottom-up approaches, an organization can adapt to the new method in that fashion most suitable to its current situation. And, finally, as the method can use logical contradiction as a means for improvement, rather than experiencing the same as a systemic or local failure, it can handle problems that other methods cannot, particularly if implemented upon a computer system.

The method described in this embodiment of the invention turns the traditional approach inside-out. It has the advantage over the traditional ‘functional’ approach of making crucial process information both measurable and explicit, rather than being left implicit. It has the second advantage of making the process information available to any element within the hierarchy (subject to message capabilities of the entity as a whole). It has the further advantage of letting the process and the results be measured for efficiency, enabling the distinction between performance and results which allows for finer-tuned management that no longer can as readily mistake good fortune for efficient use of resources. It has the still further advantage of allowing simulative rather than real-world testing of alternative methodologies and strategies, thereby creating an environment supportive of experimentation and advances. And it has the advantage of bringing the organization fully into the information economy by instantiating the organization as information (as to goals and processes and knowledge combined), allowing a full and measurable capitalization of the human experiences which represent the real wealth of the new economy.

A further advantage of this method (a corollary of the third advantage mentioned above) is that it mitigates the risk and decreases the costs of learning by experience, both for each individual employee (at any level) and for the organization as a whole. Incremental, granular, operational responsibility can be tied more directly to both results and the processes by which such results were obtained, thereby allowing the evolution of finer-grained and subordinate rules for particular new situations. As this method produces both richer (in detail and number) and finer (in precision of both operation and feedback measurement) rules for operation, the entity as a whole grows effectively ‘smarter’ about both the external environment and about its own internal processes and interactions with said external environment, by developing through inference appropriate rules of behavior. Accordingly, the risk of a catastrophic failure affecting the entirety of the entity decreases with the spread of the new rules. So, too, decreases the risk of similar catastrophic failure for the entire system by the failure of any one particular operation or rule, or contradiction between any two rule sets. Failure of a rule at one level (whether of omission, i.e. the rule does not fire because the constraints and conditions were not properly stated or measured, or of commission, in failing to model the external world correctly) is less likely to cause failure of its parent rule. In one sense, this method empowers individual employees in the most strategic fashion appropriate to their operational capabilities and responsibilities.

A still further advantage of this method is that the increasingly fine granularity of the rules minimizes the cost of developing and testing proposed rules at a level above their proper scope, since each level inherits automatically the constraints and conditions of its predecessor and superior level. Any failure that occurs as a consequence of a developed rule being tested creates feedback that may be used, as claimed below, to redefine the higher level's constraints and actions so as to increase the chance of success for the higher-level rule. In short, the lower-level failure becomes feedback that improves both the lower and higher level's performance, over time.

Another further advantage is that the feedback process automatically provides insight into the performance and reporting between levels, thus allowing internal processes as well as external interactions to be observed. Because business objectives are stated as explicit goals, the business entity as a whole can accurately now measure its performance with far greater consistency and directly-focused applicability. Among the assessments that can be made are (this list is meant to be inclusive and exemplary, rather than exclusive): (1) accurate assessment of the risks of any decision or action at the level wherein such is made; (2) accurate assessment of the contribution of any rule towards the overall goal, with a minimum-cost/maximum benefit assessment of that rule in context being feasible; (3) accurate assessment of the deviation risk for any particular rule set, if the employees responsible for its implementation do not accurately implement the actions directed by their superiors and the current business situation(s); and, (4) accurate assessment of the relative efficiency of (a) the rule sets, and combinations of rule sets, which are active at distinct granular levels of the business entity; and (b) the cost/benefit incurred or gained by implementing finer-tuned rules and engaging in further hierarchical delegation of the current rule set, including in such assessment the increased frictional cost of additional information-passing around and amongst levels of the hierarchy as a consequence of such delegation.

### DESCRIPTION OF THE SEVERAL VIEWS OF THE DRAWINGS

This embodiment of the invention and its features, aspects, and advantages will be better understood by reference to the accompanying drawings illustrating a preferred embodiment, in which:

FIG. 1 is a graphical representation of how a business adapts current operational wisdom to this embodiment of the invention. “Managers” (1) identifies those human individuals within the business who have operational knowledge. Using any means to capture and represent this knowledge (2), each such individual will generate “Decisions” (3), which are then formulated (4) into one or more “Business Rules” (5). These are then combined across and through various levels (6) to form “Business Processes” (7), which are invoked and driven by outside events (8). As the evolution from human to incorporated knowledge progresses, these ‘standard operating procedures’ form a “Business Auto-Pilot” (9), whose performance can be monitored by and against (10) specified metrics (11). Deviations, lapses, or improvements in performance when analyzed (12) are then used to refine and tune (13) any or all of the Decisions, Business Rules, or Business Processes (14).

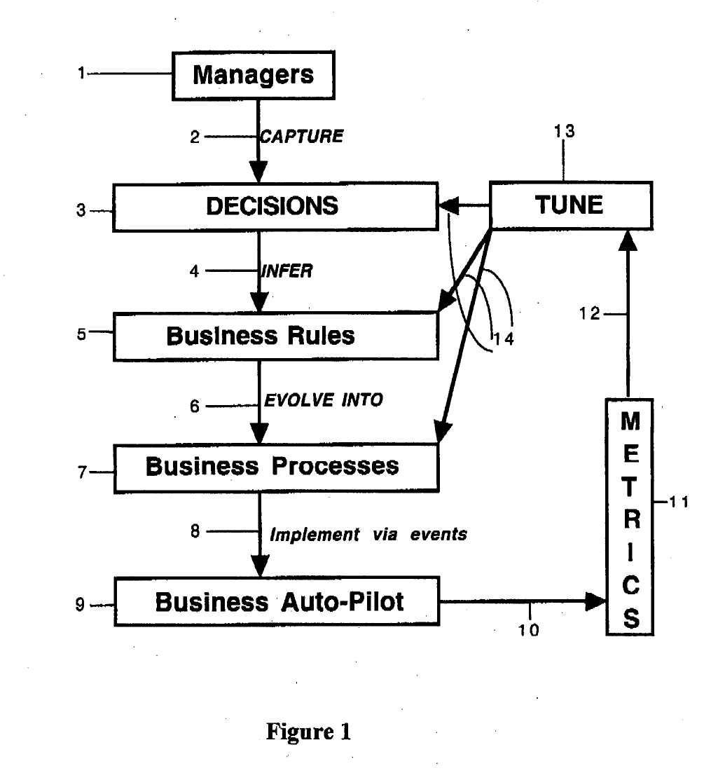

FIG. 2 outlines the major steps of the method described in this embodiment of the invention. In the first step (15), the objectives of a dynamic process (in this Figure, a for-profit business) are stated as measurable Goals. The Goals stated in (15) form a sub-set describing the objective of growing the business. In the second step (16) each production or process rule which drives growth of sales is stated as a condition plus action; according to (16), customers will have orders shipped when the item is in stock, but if the item is not in stock, a new one will be produced. In the third step (17), the delegation of duties relevant to obtaining customers and responding to customer orders is specified. The particular individual mentioned in (17) inherits the condition as a goal of ‘Obtaining New Customer’ from the existing rule (an intermediate step, detailing ‘North American Sales’ as part of ‘Sales’ was left out of the drawing as one obvious to any practitioner skilled in the practice of sales or business delegation). In the fourth step (18), the operation of the method becomes automatic as the external world is compared to the conditions stated in the Rules and the data concerning performance becomes updated as actions leading towards Goals takes place. The fifth step (19), is internalizing feedback by monitoring performance and the real world against the previously specified Goals, with specific handling of contradictions by internal modification until they are resolved.

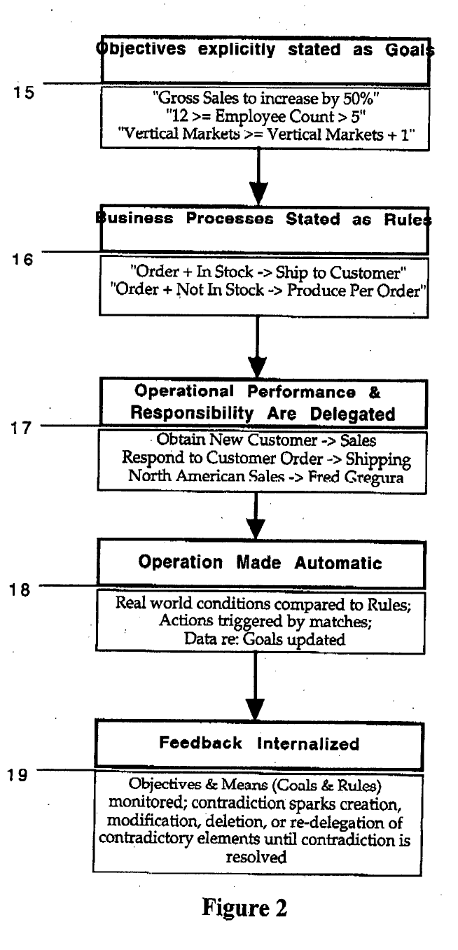

FIG. 3 is a general outline of how a computer program, or a device, for instantiating this embodiment of the invention can be created out of pre-existing, state of the art tools. The various software tools included in this Figure are generally available from a variety of vendors (e.g. Oracle, Sybase, Informix, Microsoft, SAP). Moreover, their creation is now generally feasible to practitioners skilled in the art of computer programming for manifold dynamic processes, let alone for businesses; there are entire industries now established which can meet individual customer's desires.

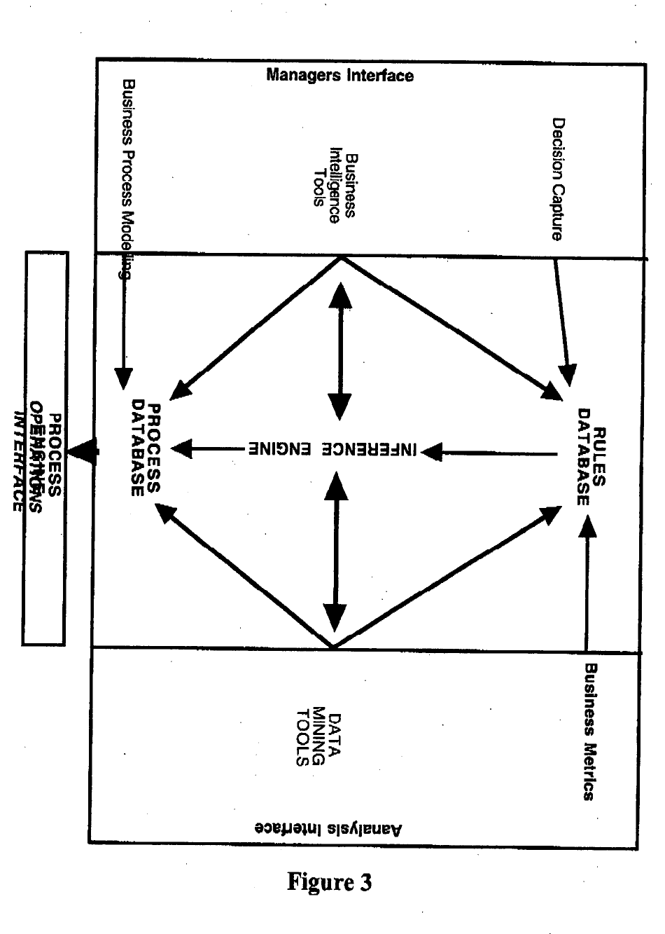

FIG. 4 is a graphical representation of the process flow that might result from this embodiment of the invention for a particular dynamic process (or business). One level of the business (20) delegates operational responsibility, authority, and accountability for a particular decision/action node (21) to a subordinate, and more finely detailed, level of the business (22). However, at this level a conflict is encountered when a logical contradiction is generated (23) when something is both true and false. Both sources of the contradiction can be clearly identified within the process flow known to (22). (An order must be shipped to meet quarterly sales quotas, though no product to fill the order exists.)

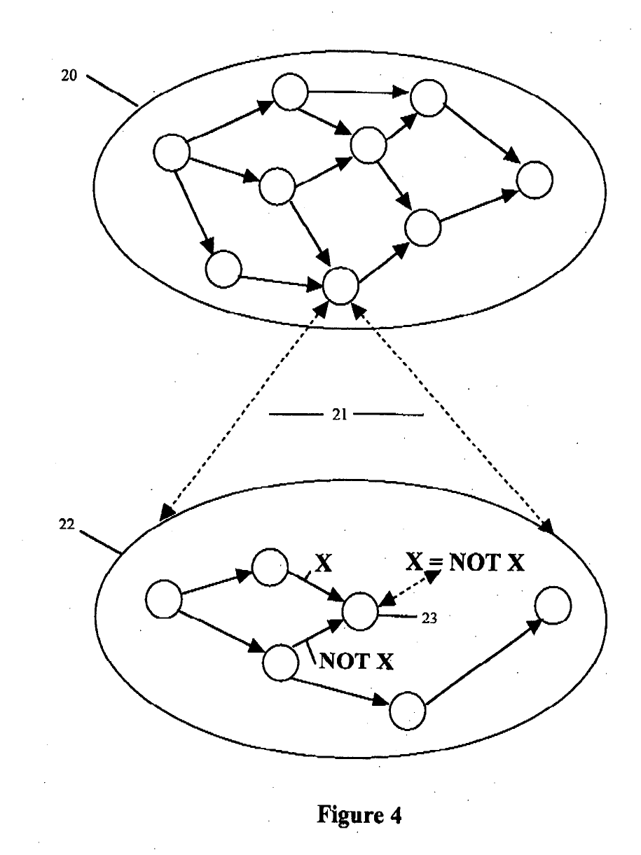

FIG. 5 is a graphical representation of how, upon experiencing the logical contradiction set forth in FIG. 4, the preferred embodiment of this invention uses the feedback to modify the method at the level where the contradiction is experienced, by modifying the process flow within (22) to include a new differentiation (between X and X′) that ensures that the otherwise-contradictory value X generates a different response than NOT X does.

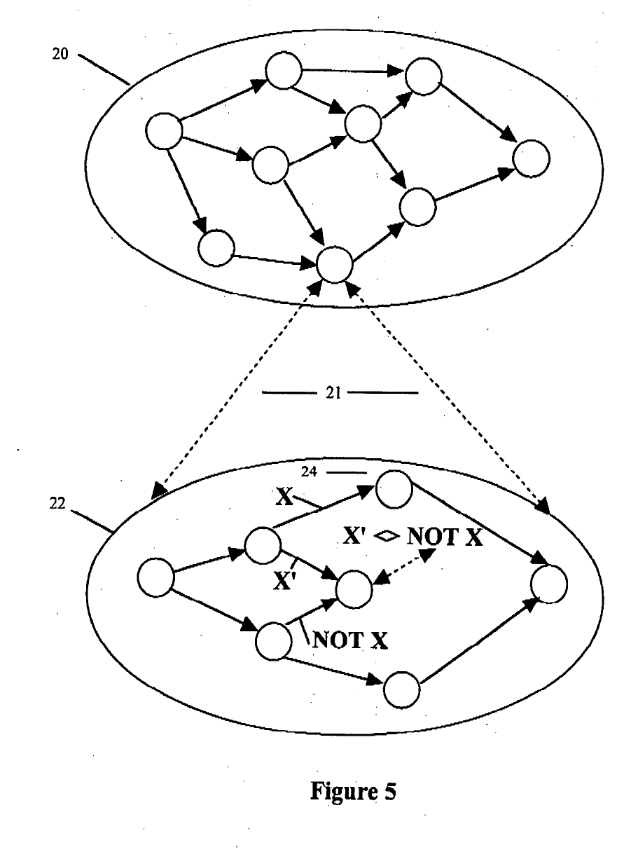

### DETAILED DESCRIPTION OF THE INVENTION

The method embodied in this invention is meant to apply to dynamic processes, i.e. processes that change the real world, including those changes which hold steady what otherwise would have changed. The method of the present invention is a method that is declarative rather than procedural, that focuses on correctly stating the goals, actions, expectations, and external circumstances as they are and as they are expected to be, in a fashion that not only allows but supports continuous adaptation and refinement to match reality as it is rather than correcting for mistaken plans as they were implemented.

The method of the present invention can be instantiated as a model of business organization, embodied in a computer program and applied to real-world problems of production, distribution, retailing, or service provision, or pre-manufactured and prepackaged and sold with the capitalization of extant business knowledge (operational and procedural both) specific and relevant for any of a number of specific vertical markets for the rapid transmission of business knowledge to new participants previously unused to modern market-oriented economic activities. It may also be used to preserve and store human knowledge (of actions, measurement, processes, organization, behavior, and external conditions) to allow the effective and timely capitalization of such knowledge so as to prevent its being lost with the retirement, transfer, resignation, or death of skilled human employees and actors within an extant organization. This method shifts management from the projection and production ‘pull’ approach of the era of mass-production, to the demand-pull approach which is suitable for the new era of mass customization. It is anticipatory rather than projective, and thus minimizes the gaps between expectations (the model of the anticipated world) and reality. Furthermore, this method lets the real world conditions rather than projected anticipations govern the choice of actions, which allows changes to propagate on their own rather than requiring continuous and focused attention by management on how things are done and what actions are taken.

For clarity of disclosure, and not by way of limitation, the preferred embodiment of this invention is described in detail with respect to the operation of a business entity with distinct, differing, individuals and levels of operative responsibility. However, this invention is not so limited. From the following detailed description it will be apparent to one skilled in the art that this invention is applicable to entities as small as a single proprietorship and as large as the largest Fortune 100 multinational, publicly-held, corporation with layers of subsidiaries and clusters of cooperative and intertwined partnerships and subordinate corporations. Furthermore, it will be apparent to one skilled in the art that this invention is likewise applicable to dynamic processes in other fields.

For example, it can be applied to the management of a global multinational corporation with multiple national subsidiaries, all engaged in the production, distribution, and sales of technologically-undifferentiated, brand-dominated retail products in markets varying from mature to nascent, where the information about all aspects of the operation (from production through distribution to sales) are well-known and extensively analyzed by itself, competitors, and third parties. It could also be applied to the management of a nascent operation devising and defining both a technologically-advanced service and the market(s), channel(s), and customer(s) for said technologically-advanced service, where no one knows quite what is being sold, to whom, how, or for what in exchange.

This method provides for the most direct (in terms of applicability at the appropriate information/decision context) and effective (in terms of modifying the method and operations of the business entity as a whole) means for managing that business's operations, bringing into the closest congruence past plans, present objectives, constraints, actions, and responses, and future goals. Implementation of the decision-making and feedback systems is not imposed by any internal teleological imperative but by the external constraints triggering automatically the responses deemed most appropriate.

Definitions

A “Goal” is a preferred, real-world position. Goals may be relative (“15% more sales than last year at this time”) or absolute (“Gross Income in the next fiscal year of at least $1,000,000.00”). A Goal has a truth value that the dynamic process is intended to change from false to true. A Goal may have a temporal mode, which in turn may be implicit, explicit, or undetermined (e.g. “Next year”, “Next Quarter”, or “Later”.) Goals reflect the purpose of a dynamic process, that is, the change in actual state that the process is intended to bring about.

A “Rule” is defined as a pairing of Condition and Action. The triggering of any rule implicitly affirms that the Condition for that rule have been determined to be true, i.e. real. Both a Condition and a Rule may have zero, one, or more logically independent portions linked by any measurable operator.

A “Rule Set” is one or more Rules with at least one common Element, even if said common Element is only membership in the same Rule Set, gathered together.

A “Condition” is defined to be a particular factual circumstance in the real world, such as a market situation, a business event, or any other discrete and measurable happening or truth. Even an individual's decision (e.g. “It's time to start the fall inventory build-up”) can become a Condition (“Time To Start Fall Inventory Build-up=NOW”). A Condition can be either a factual circumstance internal or external to a business or a dynamic process. A Condition can be quite complex, and can combine various factual circumstances, both conjunctively and disjunctively (“At least two out of three managers agree to sell the company, and the cost/benefit of doing so meets our guidelines, but the market is not temporarily depressed”).

An “Action” is defined to be a particular dynamic operation that will in turn create a new particular factual circumstance. An “Action” can be, for example, a business event (e.g. “Order new inventory”), a request to a human for information or for a decision (“Should we use supplier A or supplier B?”), a decision to set a new Goal (“Increase sales by a further 20%”), or a decision to set a new constraint (“No expenses above $5,000,000 may be authorized by anyone other than the president or treasurer”). Additionally, an “Action” can also include creation, modification, or deletion of a Rule (for example, when an internal contradiction is found).

A “Constraint” is a measurable value (such as the existence or non-existence of an item in inventory, the price of an item, or the presence of all necessary inputs for manufacturing an item) that must be satisfied, i.e. true, before a Rule incorporating that Constraint may be activated. The distinction between a Condition and a Constraint is that the condition permits a rule to activate if true, while a constraint prevents a rule from activating if true. (For example: “At least 20% of all sales by dollar value must come from products created within the past two years” is a Constraint.) The difference between a Condition and a Constraint may be in form (“If A is true” vs. “Only if not-A is not-true”); but it also may reflect how the dynamic process is to handle the real world problem of an unknown middle value that is not known to be either true or false.

“Measurable” means reducible to an objective and transcribable value. Measurable values include any numerical or ordered value, true or false value, membership of a set, any duration, or any particular mensuration. (“Sales of more than $2,000,000”; “Sales greater than last year's”; “from any EEC member”; “within thirty days of receipt of an invoice”; “weighing more than 30 tons”.) A value that must be determined by a human being is measurable only to the extent that either all such possible values, or the process(es) for such reduction (including the specification of the individual human responsible for completing the process) are specified. (E.g. “One can like, be neutral about, or dislike, the product; these are the only emotional reactions we care about.” “The wine is deemed salable for more than $5 per bottle by the senior oenologist on site at the time of bottling.”)

“Delegation” is the assignment of responsibility, authority, and accountability for operational performance and reporting to a particular actor, whether human or automated.

An “Element” is any of a Goal, Rule, Rule Set, Condition, Action, Constraint, Measurable value, or Delegation.

### Preferred Embodiment

In the preferred embodiment, the method of the invention is used for a dynamic process constituting a business, and consists of the following major steps:

First, the business' objectives are explicitly stated as a set of measurable goals and constraints. The degree of specificity is directly commensurate with the authority of the deciding and acting individual. Stating a business objective includes as a necessary step defining a successful outcome (defining an unsuccessful outcome is optional, but stating either an unsuccessful outcome or a durational limit to satisfaction is recommended to ensure that the objective becomes accessible to the feedback process). These objectives are stated declaratively and (in the preferred embodiment) are stated so as to be suitable for reduction to a form of or logic and instantiation on a computer. Though the latter step is not necessary, it promotes operational efficiency, greater certainty, and speed in continued dynamic realization of the method.

For example, a business' objective might be stated as “Ensure that every communication is responded to within the same business day as it was received,” [measurable goal] “in order of priority and using the closest similar method outgoing as was used incoming” [constraints]. An executive vice-president may institute a further objective “Only pass directly on to me a limited set of communications for my personal handling of the response” [measurable goal] “those communications being, in order of priority: from known customers, from other individuals in this business (superiors before peers before subordinates), from previously-established vendors offering new items or changing terms of price, payment, or delivery, or from my family” [constraints], and pass this secondary objective down to the office receptionist.

This step is the most important of all the steps, as it defines for the business entity the sandbox, the game in which it is engaged, and the distinctions between winning and not-winning (which may comprise continuing to play, losing, or both). Measurable goals are specifically stated in order to attain the following: (1) properly assess risks; (2) evaluate the minimum and maximum contribution of any rule to the overall goal; (3) determine the deviation risk for any particular rule set; (4) evaluate performance by any individual, against both their particular goals and the higher-level goals of the business; and (5) assess the relative efficiencies of (a) rule sets and combinations of rule-sets, and (b) finer tuning of subordinate rules, either new rules or new sub-levels of rule-sets (i.e. further delegation).

This step may be implemented from the top down, the bottom up, or any combination of both directions. Moreover, goal sharing, or overlap, both between disparate levels and across peer groupings, is explicitly permissible, thereby avoiding confrontation or race-condition problems.

Second, the means for meeting the business' objectives are stated as a set of rules. Each rule contains both a precondition and a response (also known as a condition and action). These rules are again stated declaratively; and they are stated as a set rather than in a hierarchy, thereby permitting their operation in any combination. However, the precondition of one particular rule may require the results of another rule, thus establishing their actual operation (in real-world circumstances) as a partially-ordered set (sometimes called a business process in the business community). This allows the business to continually modify its actual operation to the most effective set and dynamic pattern of operations by letting the real-world conditions, rather than an externally-imposed preconceived hierarchy of operations, dominate the business' behavior and interactions with the real-world through a dynamic, flexible, and adaptive model.

The identified actions of any set of rules become a set of objectives or goals which can be further delegated, and the means for meeting this further set of more detailed objectives can themselves be stated as a set of rules. This hierarchical process of defining delegatable objectives and the means for meeting them as a set of rules, the actions of which define further objectives, can continue to any degree of specificity or resolution.

In the preferred embodiment, any rule set will be incrementally augmented as more information about the real-world conditions and possible future states becomes known. Developed rule sets need not be consistent at a particular level, as long as mutually contradictory sets cannot be invoked by identical initial conditions. (The only differentiation could be a last-minute random determination as to which set to invoke.) Rules will be stated in a form that makes explicit why actions are undertaken and what is to be achieved, rather than focusing (solely or foremost) on what or how something is to be done. Process information is thereby made explicit rather than implicit and, because it is tied to measurement, susceptible to comparison and improvement.

For example, if one rule set for the receptionist were to state: ‘Upon entering the office, institute action to return all telephone messages before proceeding to act on the day's e-mail’, and a second rule set were to state: ‘Upon entering the office, institute action to return all e-mail messages before proceeding to act on to the day's telephone messages”, these rule sets would be potentially inconsistent. Yet as long as a precondition is established to differentiate between them, no such contradiction would actually be encountered. (Examples of such a precondition might be: “Upon the vice-president's returning from an electronics forum, e-mails get priority”; “On Tuesdays, telephone messages get priority”, or “In the absence of any other guideline, randomly select a rule-set and stick with it for that day, to test its effectiveness.”)

One advantage of this method is that, unlike a hierarchical approach where a contradiction becomes a irrecoverable catastrophe, in this method a contradiction without sufficient differentiation can be rapidly identified and becomes the opportunity to correct, redefine, and re-partition the rule sets so as to remove a flaw in the business' operational flow. For not only can a general rule for handling contradictions be declared, but that rule can include in its actions the imperative and processes for modifying the business' internal rule-set so as to obviate further instantiations of such a contradiction by developing the proper differentiations at the correct level. (For example: “If faced with contradictory rules, if your rank is below vice-president, pass the contradiction along to your superior with a request for immediate clarification of what rule to instantiate to obviate such contradictions in the future and, upon receiving such a rule, include it in your operational guidelines; if your rank is vice-president or above, immediately instantiate a differentiation or make a personal choice as to which rule set to apply, record your decision and grounds therefor in a memo to the president, and then follow the selected rule set.”)

Third, operational performance of the rules, and responsibility for attaining the predefined goals and obeying the predefined constraints, are delegated throughout the business to specific individuals, other business units, or even to automated subsystems. Subordinate rule sets inherit conditions as constraints, and actions as goals, and responses or actions as conditions. Superior rule sets receive responses as results. Peer rule sets receive responses as conditions. Delegation automatically occurs as goals and constraints are handed ‘down’ a hierarchy of actors. Throughout the business responsibility, accountability, and authority remain linked. This alone solves a great many business problems within any organization.

In the preferred embodiment of this invention, delegation has three distinct phases. A manager ‘delegates’ operations to the extent that he passes down rule sets and the responsibility for carrying their dictates out. A manager delegates authority to the extent that he passes down the ability to establish, modify, or delete rule sets. And a manager delegates accountability to the extent that he passes down the ability to alter measurements (or methods of measurement) of the predefined success or the measurement-process itself. The delegation and the resolution of inconsistencies is always done in a step-wise, localized fashion rather than broadly and vaguely across the hierarchy as a whole, since the delegation is tied directly to the particular rules, constraints, and measurements assigned to each individual rather than to their place in a hierarchy.

For example, the vice-president and receptionist both inherit the top-level objective (“Ensure that every communication is responded to within the same business day as it was received”) as a goal, the constraints of that top-level objective (“in order of priority” and “using the closest similar method outgoing as was used incoming”) as constraints, and apply these to their own rule-set and actions. Thus the receptionist will pass on to the vice-president only those messages meeting the conditions of the additional rule (“pass directly on to me a limited set of communications for my personal handling of the response”) and handle the remaining messages; and both will respond within the same business day according to the constraints they are operating under. Failure to perform, or the need to alter a rule (“What do I do when a U.S. Government attorney calls for you?”), are equally measurable and serve as the inspiration for amendment, creation, or deletion of a rule at the level where the need to meet the real-world complexity occurs.

Fourth, the business' operation is made increasingly automatic, that is, responsive to external conditions rather than internal expectations, as the rule-satisfaction is made responsive to conditions as they exist in the real world and are applied to the rule-set(s). Actual implementation of business decisions and activities is governed by the satisfaction of the initial conditions for any particular rule or set of rules, which in turn initiates the operational process that produces measurable results. Even the failure to trigger a single rule, over time, can itself become the source of a rule and measurement; e.g. “If no sales of new product X are made within three months, cancel production of new product X.” In the absence of specific rules on priority for actuating other rules, the entire set is continuously examined against existing conditions.

For example, each new incoming message would trigger the precondition for the rule stated above (“Ensure that every communication is responded to within the same business day as it was received”). If more messages are received at one time than can be responded to, either the first condition (“in order of priority”) or second condition (“using the closest similar method outgoing as was used incoming”) may govern the response. A lower-priority message may be responded to before a higher-priority message simply because the higher-priority message would require an asset (e.g. the fax machine) which is currently tied up with another response. Or the receptionist may delay responding to an incoming message while transferring the sub-set meeting the appropriate preconditions to the vice-president for his handling, as the best means of meeting the overall goal of responding to every message.

In the preferred embodiment of this invention, the instantiation of the rule sets and data describing both internal operations and goals, and external conditions and reactions, is continuously updated to match the reality as experienced rather than matching preconceived (planned) expectations. This prevents the disjunct between planning and reality that forces organizations into ‘catch-up’ or ‘reactive’ mode and best permits proactive or forward-looking behavioral patterns to emerge. As soon as any trend or dynamic can be observed and reduced to a declarative statement (e.g. ‘sales of low-end shirts, defined as costing less than $15, are down 20% over last year in the EEC’) it becomes part of the rule set and can be used to govern future behavior, e.g.: ‘If anticipated sales are down below $Y0,000 in low-end products discontinue production contracts with high-cost, defined as >$2.50 per shirt, mills located where shipping costs exceed 10% of the production cost.’

Fifth, feedback is internalized, and becomes linked with, rather than disparate from, operations, as the processes for creation, deletion, modification, and correction of both objectives and means (or goals, constraints, conditions, and actions) are declared as explicit consequences of rules governing the business. (For example: “If no objective is met within a day, new rules specifying objectives that can and will be met within a day will be created, unless existing rules can be further differentiated to specify objectives that can be met within a day”, can be a rule for modification. “If sales of all products do not include at the end of the year 20% by dollar value from products created within the past twelve months from the date of sale, research and development will be increased by 10% and managerial bonuses at all sub-units not meeting such goal will not be authorized”, can be a rule for correction. And “If two rule sets are contradictory and after a year no measurable advantage can be perceived for following either one, despite random testing of each, then one such set selected at random shall be deleted”, can be a rule for deletion.)

In the preferred embodiment, modification of a goal is done by creating a condition that when detected by the same level as a goal causes that level to modify its own rules (self-modifying), rather than requiring intervention of a higher level of the hierarchy.

In the best embodiment of this method, the modification of goals is done by creating a condition that requires the level of operations where that goal is specified to send a message that requires the goal to be modified, rather than forcing the message to pass upwards and the consequential modification of the goal to be passed downwards through the hierarchy. This is the equivalent of ‘flattening’ a hierarchy and putting decision-making operation, authority, and accountability into the hands of the employees best able to perceive both the need for and the direction of desired change. This closed-loop decision making, where action, measurement, correction, and reporting are all integrated, reduces the management effort required to the theoretical minimum and, as long as the model meets reality, to zero.

### BENEFITS OF THE INVENTION

Because the business' success, and thus that of the individual(s) acting on its behalf at any particular point, has been defined by measurable goals (i.e. actions inherited from superior levels), as soon as a point of failure (and the extent of the failure) becomes clearly identifiable, at the same time it specifies where the corrective measure should best be taken. This internalization of feedback produces a number of particular benefits.

First, the element of surprise accounting disappears, as events are monitored with regard to the real world rather than projected assumptions. Second, the disjunction between the levels of authority to act, operational failure, and accountability for failure, common to many current businesses, disappears. For if conditions are not satisfied (so no action took place) the level at which the conditions were incorrectly stated can be determined; while if conditions were satisfied but the action failed operational responsibility can be determined; and if conditions satisfied contradictory rule-sets the need for differentiation and instantiation of adequate differentiation can be determined and are automatically established at the appropriate level, that being where the inadequate differentiation became perceptible.

Second, since any failure creates its own feedback (whether the failure arose from inadequately determining real-world conditions, failure in operational action, or failure in adequate differentiation), the method adapts to both internal and external weaknesses and thus continually improves in a dynamic and flexible fashion. Changes are incremental and propagate throughout the organization (conditions being inherited and results being transferred upwards and sideways) with a minimum of supervision and hierarchical interference.

Third, the amount of risk experienced is reduced to the minimum possible at that particular level of specification. Because the rules are incrementally, and granularly, resolved the risk of rule (and thus process) error is decreased. Both the overall risk of a systemic rule failure, and the particular risk of a rule's firing (or not firing) are reduced; the former because the process information is made explicit and measurable, the latter because the failure is both accountable and can be isolated to the particular level of that rule's operation.

Fourth, the risk of delegation and increasing specification is reduced. The more granular, that is, the more particular the rule set of a subordinate level, the more feedback can improve that level without modifying a higher level and (through such upward modification) risking destabilizing or creating contradictions within a second, peer, level of operations. By distinguishing between operational failure and rule failure a distinction between business assumptions, the real world conditions, and human performance becomes possible, allowing for corrective measures to be aimed at the precise weakness.

Fifth, composite goals can be met by being shared rather than dictated to disparate subordinate pieces. For example, a goal of maximal growth can be shared to five equal sub-divisions, each growing to the limit they can (dictated by external conditions and internal performances), without the higher-level manager having to either try to attain equal growth across all sub-divisions, overload himself with supervisory detail, or focusing on a particular sub-division to the exclusion of the other (and risk guessing wrong about the one most capable of lifting the entire group's performance).

Although the present invention has been described chiefly in terms of the presently preferred embodiment, it is to be understood that the disclosure is not to be interpreted as limiting. Various alterations and modifications will no doubt become apparent to those skilled in the art after having read the above disclosure. Such modifications may involve other features which are already known and which may be used instead of or in addition to features already described herein. The algorithms herein are not limiting but instructive of the embodiment of the invention, and variations which are readily derived through programming or mathematical transformations which are standard or known to the appropriate art are not excluded by omission. Accordingly, it is intended that the appended claims are interpreted as covering all alterations and modifications as fall within the true spirit and scope of the invention in light of the prior art.

Additionally, although claims have been formulated in this application to particular combinations of steps or elements, it should be understood that the scope of the disclosure of the present application also includes any single novel step or element or any novel combination of steps or elements disclosed herein, either explicitly or implicitly, whether or not it relates to the same invention as presently claimed in any claim and whether or not it mitigates any or all of the same technical problems as does the present invention. The applicants hereby give notice that new claims may be formulated to such features and/or combinations of such features during the prosecution of the present application or of any further application derived therefrom.

I claim:

1. A computer implemented, rule-based adaptive system for achieving objectives without requiring a complete pre-defined process comprising:
(a) incorporating a first dynamic pattern of operations in a first dynamic process;
(b) identifying at least a first set of real-world conditions;
(c) determining that the first set of real-world conditions drives the first dynamic pattern of operations and causes at least a first behavioral pattern to emerge;
(d) declaring and stating an objective of said first dynamic process as a set of measurable Goals and Constraints;
(e) declaring and stating at least one objective Rule Set having a plurality of Rules, said Rules in the said objective Rule Set being defined to accomplish at least a part of said objective by the combination of at least one subset thereof:
wherein the Rules in said objective Rule Set may act in any order subject to the limitation that, for any specific Rule in said objective Rule Set, that specific Rule's Condition and applicable Constraints must be satisfied before that specific Rule's Action may occur;
(f) delegating to at least one specific set of Actors consisting of at least one Actor:
at least a first subordinate objective, subordinate to the objective, stating the first subordinate objective as a subset of subordinate, measurable Goals and subordinate Constraints;
a set of Rules for accomplishing said first subordinate objective;
authority via at least one Rule stating authority for attaining the subordinate, measurable Goals of said first subordinate objective;
accountability via at least one Rule stating accountability for attaining the subordinate, measurable Goals of said first subordinate objective; and,
responsibility via at least one Rule stating responsibility for attaining the subordinate, measurable Goals of said first subordinate objective subject to the Constraints and subordinate Constraints;
(g) determining if at least one Rule's Condition is satisfied and if so triggering said Rule's Action;
wherein said Rule's Condition incorporates at least one Measurable value from at least one member of a set of sources; and,
said set of sources comprises a source internal to said first dynamic process, a source external to said first dynamic process, and a source in the real world;
(h) modifying at least one Element of said dynamic process through the Action of at least a Rule whose Condition is triggered by at least one input from an event in the real world;
(i) defining any Actor as being at least one member of an Actor set comprising human agent, semi-automated agent, and automated agent;
(j) defining any Element as being one member of an Element set comprising a Goal, Rule, Rule Set, Condition, Action, Constraint, Measurable value, and Delegation;
(k) defining each Rule so as to comprise a Condition that is satisfied when it evaluates to a specified and predetermined value and an Action that is triggered when the Condition is satisfied;
(l) determining the triggered Action of at least a first Rule and its relative order with respect to a second Rule's Action, and therefore the behavior of the dynamic process, at least partially by logical inference from Conditions and Constraints rather than said relative order being predetermined and required by human mandate;
(m) executing automatically at least a subset of the dynamic pattern of operations that progresses towards said objective, defining said subset of the dynamic pattern of operations as comprising a plurality of operations, each operation therein being temporally contiguous to at least one other operation in said subset of the dynamic pattern of operations;
(n) specifying a plurality of Elements and implementing each of the steps of declaring and stating, delegating, determining, and modifying, through a declarative and therefore non-procedural representation; and,
(o) using the plurality of Elements to actively and declaratively implement, execute, and manage the first dynamic process.

2. A method as in claim 1 further comprising iterating at least one of the steps of declaring and stating, delegating, determining, and modifying.

3. A method as in claim 1 further comprising the step of redeclaring and restating at least one Action of at least one Rule as a second dynamic process.

4. A method as in claim 1 wherein the dynamic process represents a business's operational flow, said operational flow being that business's fundamental business activity of producing goods and services.

5. A method as in claim 1 further comprising adding at least one new Element to the dynamic process in response to at least one input.

6. A method as in claim 1 further comprising the step of using the measurable Goals and Measurable values to enable assessment of any member of a set of assessments, that set of assessments comprising risk of error, minimum contribution of any Rule to the Goal, maximum contribution of any Rule to the Goal, risk of deviation from the Goal due to the Action of any Rule, performance of at least one Actor, and relative efficiencies among any two Actors.

7. A method as in claim 1 further comprising using the deviation of Measurable values from measurable Goals for at least one member of a set comprising accounting control, regulatory control, and reporting without first requiring that the dynamic process terminate.

8. A method as in claim 1 wherein said method forms a business autopilot, which, once initiated, requires no human intervention to manage successful execution of said subset of the dynamic pattern of operations even when Actions and operations are implemented by human Actors.

9. A method as in claim 1 further comprising:
including a set of Constraints consisting of at least one Constraint;
including a first Rule Set consisting of at least a first contained Rule;
including a second Rule Set consisting of at least a second contained Rule;
including a set of ordering Rules consisting of at least one ordering Rule; and,
determining the relative order by which each first contained Rule in the first Rule Set and at least a second contained Rule in the second Rule Set are satisfied according to at least one member of a set comprising the set of Constraints, implicit Rule precedence making the Action of each contained Rule in the first Rule Set satisfy a Condition of the second contained Rule, the set of Constraints, and the set of ordering Rules.

10. A method as in claim 1 further comprising declaring and stating at least a first Rule Set and a second Rule Set, wherein the second Rule Set is subordinate to the first Rule Set, and wherein the second Rule Set inherits from the first Rule Set at least one Condition of a Rule in the first Rule Set as a Constraint on the second Rule Set and at least one Action of a Rule in the first Rule Set as a Goal of the second Rule Set.

11. A method as in claim 1 further comprising declaring and stating at least a first Rule Set and a second Rule Set, wherein the second Rule Set is subordinate to the first Rule Set, and wherein at least one change in Constraints by Action of at least one Rule of the second Rule Set is passed to the first Rule Set.

12. A method as in claim 1 wherein said declarative and therefore non-procedural representation is at least one member of a representation set comprising symbolic logic and declarative computer language.

13. A method as in claim 1 wherein for at least one Rule:
the Condition of said Rule detects a difference between at least one Element of said dynamic process and a Measurable value from at least one input, and the Action of said Rule has an effect on at least that one Element of said first dynamic process by modifying that one Element to do at least one member of a response set comprising accommodate the Measurable value, and adjust performance of said dynamic process as indicated by the Measurable value.

14. A method as in claim 1 further comprising analyzing the efficiency of a business operation by measuring the deviation of Measurable values from measurable Goals.

15. A method as in claim 1 further comprising:
incorporating a set of resolving Constraints comprising at least one member of a resolving set comprising a resolving Constraint and a resolving Rule;
incorporating at least one ambiguous Rule; and;
using set of resolving Constraints to determine whether the ambiguous Rule's Action will be triggered when the evaluation of the ambiguous Rule's Condition is not a value that has been otherwise determined to cause the ambiguous Rule's action to trigger.

16. A method as in claim 1 wherein, in the step of delegating, at least one member of what is delegated to one specific Actor is a consequence of the Rules, Constraints, and measurements associated with an Actor.

17. A method as in claim 1 wherein at least one Element maintains consistency among any combination of authority to act, responsibility, response to operational failure, and accountability.

18. A method as in claim 1 wherein at least one Rule makes explicit why Actions are undertaken and what is to be achieved.

19. A method as in claim 1 further comprising replacing a first unrefined Rule by a set of refinement Rules that include at least the Action of the first unrefined Rule without the set of refinement Rules including the first unrefined Rule.

20. A method as in claim 19 further comprising:
incorporating a first risk of error associated with the first unrefined Rule;
incorporating a second risk of error associated with a second refinement Rule belonging to the set of refinement Rules;
wherein the second refinement Rule has the least risk of error of any refinement Rule in the set of refinement Rules; and wherein the second risk of error is not greater than the first risk of error.

21. A method as in claim 1 wherein the step of declaring and stating at least one objective Rule Set comprises stating at least a first objective Rule Set and a second objective Rule Set, wherein the first objective Rule Set operates at a first level of the dynamic process and the second objective Rule Set operates at a second level of the dynamic process.

22. A method as in claim 21 wherein said first and second levels are indistinct and said first objective Rule Set and said second objective Rule Set form a peer to peer organization.

23. A method as in claim 21 wherein said first and second levels are distinct and said first objective Rule Set and said second objective Rule Set form a hierarchical organization.

24. A method as in claim 1 further comprising declaring and stating at least a first Rule Set and a second Rule Set, wherein the second Rule Set is subordinate to the first Rule Set, and wherein the first Rule Set further receives, from the second Rule Set, the result of an Action by a Rule of the second Rule Set as satisfaction of at least one Condition of a Rule of the first Rule Set.

25. A method as in claim 24 wherein the first Rule Set further comprises at least a superior objective and wherein the Action of the second Rule Set conveys information to the first Rule Set sufficient for the first Rule Set to alter at least the superior objective when the superior objective does not conform to a Measurable value from the real world.

26. A method as in claim 1 further comprising:
including at least a second Rule Set comprising a set of Rules that are connected and have no Rule for which both its Condition is not satisfied by some combination of Actions and events, and its Action does not eventually in combination with the Actions of other Rules in the set satisfy the Conditions of at least one Rule;
including at least a first Satisfied Rule in said second Rule Set whose Condition has been satisfied at least once; and,
further including a set of pairs comprising an identification of at least one satisfied Rule and a time said satisfied Rule was satisfied, said set of pairs being partially ordered and constituting a first subordinate process.

27. A method as in claim 26 wherein the second Rule Set comprises the entire set of satisfied Rules of the first dynamic process and no explicit ordering of the Rules in the second Rule Set is provided in defining said first dynamic process.

28. A method as in claim 1 wherein said set of Rules includes at least one anticipatory Rule, the satisfaction of the Condition portion of said anticipatory Rule being merely a possibility and neither a prediction nor a mandate, when said anticipatory Rule is initially stated.

29. A method as in claim 28 wherein said Condition of said anticipatory Rule incorporates at least one conjunct which, at the time of creation of the Rule, incorporates a Measurable value that is contrary to the known and projected state of the real world.

30. A method as in claim 1 further comprising:
storing said declarative and therefore non-procedural representation in a static and stable form; and,
preserving human knowledge of said dynamic process.

31. A method as in claim 30 further comprising the steps of
organizing in a first business entity said declarative and therefore non-procedural representation of said dynamic process for conveyance to a second business entity; and,
conveying said declarative and therefore non-procedural representation from the first business entity to the second business entity.

32. A method as in claim 30 wherein said declarative and therefore non-procedural representation of said dynamic process stores knowledge of at least one member of a set comprising organizational management, at least one model of business organization, at least one operational process, and at least one strategic process.

33. A method as in claim 30 further comprising the steps of:
retrieving at least a portion of said declarative and therefore non-procedural representation; and,
instantiating said portion of said declarative and therefore non-procedural representation as a second dynamic process in a business.

34. A method as in claim 1 wherein the step of delegating to at least one specific Actor further comprises:
a first Actor at a first level stating a plurality of business Rules comprising possible Conditions, each Condition comprising at least one member of a set comprising factual circumstance, market situation, business event, and Measurable value, and joined with at least one corresponding desired Action matching a first measurable Goal;
a second Actor at a second level identifying a Goal-achieving set of business Rules enabling said first measurable Goal to be attained; and,
said second Actor communicating at least a first result of the Goal-achieving set of Rules to said first Actor.

35. A method as in claim 34 wherein said plurality of business Rules are responsive to a plurality of events, and wherein the actual operation of the plurality of business Rules are combined to form a business process independent of any pre-existing definition of the business process.

36. A method as in claim 34 wherein said measurable Goal is expressed as at least one Goal Rule comprising a Goal Condition which identifies said measurable Goal and a Goal Action which specifies any combination of the members of a measure set consisting of a measure of success, a measurement Constraint, and a measure of failure.

37. A method as in claim 34 wherein the first Actor further:
identifies the maximum acceptable risk associated with each risky Rule in a first risky Rule Set at the second level;
determines the risk associated with each risky Rule; and,
for each risky Rule in the first risky Rule Set with risk that is not below the maximum acceptable risk associated with said risky Rule, further refines Actions of each such risky Rule by delegating its Actions as a Goal to a third Rule Set, and the third Rule Set is at a third level.

38. A method as in claim 34 wherein the step of communicating further comprises stating at least one Rule having at least one Condition responsive to said desired Action and having an Action that performs said step of communicating.

39. A method as in claim 34 wherein said first result is a qualitative measure of at least one member of a set of measurable properties comprising performance and Goal completion.

40. A method as in claim 34 wherein said first Actor effects Delegation to at least one subordinate Actor any combination of any number of the members of a Delegation set consisting of responsibility, accountability, and authority that belong to the first Actor.

41. A method as in claim 40 wherein said first Actor further effects Delegation by a Delegation Rule comprising at least one Delegation Condition which tests the appropriateness of achieving said desired Action and at least one Action which identifies at least one Actor as recipient of said Delegation.

42. A method as in claim 41 wherein the Delegation Rule delegates authority by at least one member of a set comprising establishing at least one Rule Set, modifying at least one Rule Set, and deleting at least one Rule Set.

43. A method as in claim 40 wherein the first Actor delegates authority by at least one member of a set comprising establishing at least one Rule Set, modifying at least one Rule Set, and deleting at least one Rule Set.

44. A method as in claim 40 wherein said Delegation of accountability is accomplished by enabling at least one member of a set, comprising said second Actor and said second Rule, to alter at least one member of a set comprising measurement of predefined success and measurement process.

45. A method as in claim 34 further comprising identifying a second Actor (a) according to a Goal stated as some combination of a set of requirements Rules and a set of requirements Constraints, and (b) according to measurements stated as a set of capabilities Rules.

46. A method as in claim 45 wherein each requirement Rule in said set of requirements Rules comprises both:
at least one requirements Condition identifying at least one member of a set comprising the desired Action and at least one capability required to accomplish said desired Action; and,
at least one requirements Action identifying at least one member of a set comprising at least one capability of said second Actor and said desired Action.

47. A method as in claim 45 wherein each capability Rule in said set of capabilities Rules consists of at least one member of a set comprising:
at least one capabilities Condition identifying at least one Actor and at least one capabilities Action identifying at least one capability of said Actor; and,
at least one capabilities Condition identifying at least one capability, and at least one capabilities Action identifying at least one Actor having said capability.

48. A method as in claim 45 further comprising a step of matching said second Actor with said desired Goal by at least one criteria for comparing at least one requirements Rule and at least one capabilities Rule.

49. A method as in claim 48 wherein said criteria is established using at least one member of a match set comprising a best fit match algorithm, a fuzzy match algorithm, an approximate match algorithm, and an exact match algorithm.

50. A method as in claim 1 wherein the step of modifying at least one Element through the Action of at least a Rule whose Condition is triggered by at least one input from at least one real-world event; further comprises:
defining a first adaptation process comprising at least one adaptation Rule;
constructing the adaptation Rule from a third Rule and requiring in the adaptation Rule's Action at least one member of a set of Actions comprising Element creation, self-modification, feedback, contradiction resolution, conflict resolution, correction for failure, and decision making, each of which is not already any previously existing Rule's Action;
satisfying the Condition of the adaptation Rule through an event; and,
affecting at least one Element through the Action of the adaptation Rule.

51. A method as in claim 50 wherein said first adaptation process is independent of any external agent.

52. A method as in claim 50 further comprising:
monitoring performance by and against specific metrics;
satisfying the Condition of the adaptive Rule by performance deviations from the specific metrics; and,
selecting the Action of the adaptive Rule to be representative of at least one member of a set comprising business events, business measures, business decisions, business Rules, and business processes.

53. A method as in claim 50 further comprising:
modifying, through the Action of at least one adaptation Rule, at least a first changed Rule instantiated at a first level;
effectively modifying through the first changed Rule instantiated at a first level at least a first Goal of the first level; and
permitting but not requiring intervention from a higher level.

54. A method as in claim 50 further comprising:
continuously monitoring for at least one occurrence of the at least one real-world event; and,
continuously modifying the Elements of the dynamic process, in response to the occurrence of the at least one real-world event.

55. A method as in claim 50 further comprising:
incorporating at least one member of a set of dynamic processes comprising creation, deletion, modification, and correction of both objectives and Elements;
linking the adaptation process to at least one member of the set of dynamic processes; and,
modifying the objectives and Elements by the adaptation process according to at least one member of a set comprising Conditions and Constraints.

56. A method as in claim 50 wherein the step of modifying at least one Element comprises:
detecting a contradiction;
changing at least one Rule Set, further comprising:
identifying at least a first and second conflicting Rule; and,
resolving the contradiction by at least one member of a set comprising adding a new Constraint, altering a existing Constraint, adding a new Rule, altering at least one of the first and second conflicting Rules, and eliminating at least one of the first and second conflicting Rules; and,
logically differentiating the Actions of the first and second conflicting Rules.

57. A method as in claim 50 further comprising reducing at least one operational latency in the dynamic process through the Action of the adaptation Rule.

58. A method as in claim 50 wherein the adaptation Rule's Condition is satisfied when a first contradiction occurs, and the adaptation Rule's Action modifies at least one Element.

59. A method as in claim 58 wherein the first contradiction comprises at least first and second logically-conflicting Elements, and the adaptation Rule's Action selects one of the conflicting Elements through at least one member of a set of selection techniques comprising random selection, deterministic selection, and arbitrary selection, and modifies the selected Element.

60. A method as in claim 59 wherein the modification of the selected Element prevents simultaneous application of the first and second logically-conflicting Elements.

61. A method as in claim 58 wherein the first contradiction comprises at least first and second logically-conflicting Elements, and the adaptation Rule's Action alters at least one of the first and second logically-conflicting Elements and creates a differentiation between the first conflicting Rule's Condition and the second conflicting Rule's Condition, said differentiation preventing the first conflicting Rule's Condition and the second conflicting Rule's Condition from being satisfied by the same set of measurable inputs and Elements.

62. A method as in claim 61 wherein the adaptation Rule's Action alters at least one of the first and second logically-conflicting Elements, modifies the first logically-conflicting Element to include a Constraint not present in the second logically-conflicting Element, and prevents the possibility of the first and second logically-conflicting Elements from simultaneously occurring.

63. A method as in claim 50 wherein the step of constructing the adaptation Rule further comprises:
stating the adaptation Rule's Condition to be satisfied when a first failure occurs; and,
stating the adaptation Rule's Action to both incorporate modification of at least one Element and effect a correction for the first failure.

64. A method as in claim 63 wherein the first failure comprises not attaining a first Goal, and the modification of at least one Element enables the first Goal to be attained by correcting at least one member of a set comprising at least one cause of the first failure and at least one effect of the first failure.

65. A method as in claim 63 wherein the modification of at least one Element includes at least one member of a set of steps comprising creating, modifying, and deleting a second adaptation Rule.

66. A method as in claim 63 wherein the first failure comprises not detecting a Measurable value and the modification of at least one Element comprises at least one member of a set comprising creating the Element, modifying the Element, and deleting the Element.

67. A method as in claim 63 wherein a second failure comprises not attaining a second Goal and the modification of at least one Element includes the step of redeclaring and restating at least one Action of at least one Rule as a second dynamic process.

68. A method as in claim 63 wherein the first failure comprises not attaining a first Goal and the modification of at least one Element enables said first Goal to be attained by correcting at least one member of a failure set comprising at least a first cause of the first failure and at least a first effect of the first failure.

69. A method as in claim 63 wherein the adaptation Rule's Action modifies at least a member Rule of the objective Rule Set and, when the member Rule's Condition is satisfied, the member Rule's Action modifies, without human intervention, at least a first member of the set of measurable Goals.

70. A method as in claim 63 wherein the adaptation Rule's Action modifies at least a first Adaptable Rule of a set of Rules and, when the first adaptable Rule's Condition is satisfied, the first adaptable Rule's Action modifies, without human intervention and without modification of any Rule of the objective Rule Set, at least a first member of a set comprising subordinate Goals and measurable Goals.

71. A method as in claim 63 wherein the step of declaring and stating at least one objective Rule Set further comprises:
stating at least a first objective Rule Set and a second objective Rule Set, wherein the first objective Rule Set operates at a first level of the dynamic process and the second objective Rule Set operates at a second level of the dynamic process;
and wherein the adaptation Rule's Condition effectively defines the need for a closed-loop effect in said first level and the adaptation Rule's Action changes at least one Element in said second level.

72. A method as in claim 63 wherein the step of modifying at least one Element comprises modifying at least one member of a set comprising Goal, Rule, Rule Set, Condition, Action, Constraint, Measurable value, and Delegation.

73. A method as in claim 63 wherein the step of declaring and stating at least one objective Rule Set comprises stating at least a first objective Rule Set and a second objective Rule Set:
wherein the first objective Rule Set operates at a first level of the dynamic process and the second objective Rule Set operates at a second level of the dynamic process; and,
wherein a first Goal is associated with the first level and a second Goal is associated with the second level; and the first Goal and the second Goal overlap by having a sub-goal in common.

74. A method as in claim 73 further comprising modifying the overlap to avoid at least one member of a set comprising confrontation problems and race-condition problems.

75. A method as in claim 1 wherein the step of declaring and stating at least one objective Rule Set comprises stating at least a first objective Rule Set and a second objective Rule Set, wherein the first objective Rule Set operates at a first level of the dynamic process and the second objective Rule Set operates at a second level of the dynamic process, and further comprising an organizing Rule comprising:
an organizing Condition; and
an organizing Action;
and the organizing Condition is satisfied by the Condition of at least one Rule in said first objective Rule Set and the organizing Action comprises at least the second objective Rule Set.

76. A method as in claim 75 wherein said organizing Action delegates at least one member of the set comprising a Rule Set, authority, accountability, and responsibility, and said organizing Rule creates a hierarchical Delegation.

77. A method as in claim 1 wherein the step of declaring and stating at least one objective Rule Set further comprises stating at least a first objective Rule Set and a second objective Rule Set, wherein the first objective Rule Set operates at a first level of the dynamic process and the second objective Rule Set operates at a second level of the dynamic process, and wherein the response to at least one Action of at least one Rule in the first objective Rule Set becomes at least one Condition of at least one Rule in the second objective Rule Set.

78. A method as in claim 77 wherein the first level and the second level are identical, and at least one Rule in the first Rule Set receives at least one response of at least one Rule in the second Rule Set as its Condition.

79. A method as in claim 30 further comprising:
analyzing the business operations represented in said declarative and therefore non-procedural representation; and,
refining and tuning at least one member of a set comprising Decision, Business Rule, and Business Process.

80. An apparatus for implementing a rule-based adaptive system for achieving objectives without requiring a complete pre-defined process comprising:
static memory containing:
a set of measurable Goals and Constraints of said first dynamic process;
at least one Rule Set having a plurality of Rules:
wherein the Rules in said Rule Set may act in any order subject to the limitation that, for any specific Rule in said Rule Set, that specific Rule's Condition and applicable Constraints must be satisfied before that specific Rule's Action may occur;
a declarative and therefore non-procedural representation of each Element, and any of a set of steps of declaring, stating, delegating, determining, and modifying;
means for incorporating a first dynamic pattern of operations in a first dynamic process;
means for identifying at least a first set of real-world conditions;
means for determining that the first set of real-world conditions drives the first dynamic pattern of operations and causes at least a first behavioral pattern to emerge;
means for accepting at least one input from the real world, said input comprising a Measurable value;
means for comparing any input against the Condition of all Elements contained in the static memory;
means for delegating to at least one specific set of Actors consisting of at least one Actor:
at least a first subordinate objective, subordinate to the objective, stating the first subordinate objective as a subset of subordinate, measurable Goals and subordinate Constraints;
a set of Rules for accomplishing said first subordinate objective;
authority via at least one Rule stating authority for attaining the subordinate, measurable Goals of said first subordinate objective;
accountability via at least one Rule stating accountability for attaining the subordinate, measurable Goals of said first subordinate objective; and,
responsibility via at least one Rule stating responsibility for attaining the subordinate, measurable Goals of said first subordinate objective subject to the Constraints and subordinate Constraints;
means for determining if at least one Rule's Condition is satisfied and if so subsequently triggering said Rule's Action wherein said Rule's Condition incorporates at least one Measurable value from at least one member of a set of sources and said set of sources comprises a source internal to said first dynamic process, a source external to said first dynamic process, and a source in the real world;
means for modifying at least one Element through the Action of at least a Rule whose Condition is triggered by at least one input from an event in the real world;
means for executing automatically at least a subset of the dynamic pattern of operations, defining said subset of the dynamic pattern of operations as comprising a plurality of operations, each operation therein being temporally contiguous to at least one other operation in said subset of the dynamic pattern of operations;
means for specifying a plurality of Elements and implementing each of the steps of declaring and stating, delegating, determining, and modifying, through a declarative and therefore non-procedural representation;
means for using said set of steps of declaring, stating, delegating, determining, and modifying, to further the attainment of a Goal of said first dynamic process independent of human action; and,
means for iterating through the steps of declaring, stating, delegating, determining, and modifying.
